(19) United States
(12) Patent Application Publication
(10) Pub. No.: US 2011/0204004 A1
(43) Pub. Date: Aug. 25, 2011

(54) Process for Water Treatment and Recovery of Industrial Waste Water

(75) Inventor: Callum Bremner, Penrith (AU)

(73) Assignee: FOGETY HOLDINGS PTY LTD, Penrith (AU)

(21) Appl. No.: 12/990,675

(22) PCT Filed: May 4, 2008
(86) PCT No.: PCT/AU2008/000601

§ 371 Date: Apr. 12, 2011

(30) Foreign Application Priority Data
May 4, 2007 (AU) 2007902340

(51) Int. Cl. C02F 1/00

(52) U.S. Cl. 210/805

(57) ABSTRACT

A process for the purification and recovery of a contaminated liquid, the process comprising: a source of contaminated liquid effluent, a primary filtration station having at least one filter; a first holding tank for receiving effluent from the primary filtration station, a dosing station; a mixing station; at least one other filtration station; and wherein, effluent passing from said at least one other filtration station is returnable to the primary filtration station for further filtration or recoverable from the system.

### FIELD OF THE INVENTION

The present invention relates to water conservation and more particularly to water treatment, recovery and recycling from waste water generated in industrial processes. The invention further relates to water treatment and recycling particularly associated with industrial processes and to a process for treatment and optional re treatment and recycling of contaminated wash water used for industrial cleaning.

The invention further relates to treatment and recycling of waste water used for industrial washing and which employs at least one primary filtration station, a mixing station in which chemicals are mixed with effluent, a settlement station and a final filtration station.

### PRIOR ART

### Background of the Invention

Industrial cleaning using wash water is responsible for high water consumption which is undesirable with water being an increasingly scarce resource. Water conservation is now critically important globally necessitating that industry adopt strict water conservation methods and where possible recycling. In industrial cleaning, the by product is usually highly contaminated water which cannot be returned to the water network and often is wasted. One method of dealing with the problem of contaminated waste water in industry washing is to have it collected and taken to a dump where the water evaporates and the contaminants remain. This is highly wasteful as freshwater must be used for each location job.

One example of an industrial washing system which involves high water consumption is disclosed in U.S. Pat. No. 6,129,099 which teaches a pallet washing apparatus and method for cleaning articles such as pallets, totes, containers, bins, trays, carts, and other like articles. The apparatus includes a main housing having a conveyor system, on which articles are transported into and through a washing chamber. A plurality of high pressure, jet-stream spray nozzles rotating at high speeds are supplied with a high pressure wash fluid. The spray nozzles provide rapid, powerful, knife-like jet streams of wash fluid which impact the surfaces of the articles moving through the washing chamber repeatedly to lift and blast off contaminants adhered to the articles. The apparatus is portable and includes a closed-loop water reclamation system having a plurality filter assembly and is environmentally friendly. Contaminant-entrained wash fluid is collected in a collection tank, filtered and supplied back to a clean tank for reuse. This process uses jets of wash liquid followed by basic filtering out of solids from wash water which is then returned for recycling.

It is common for the articles, particularly metal articles, to require cleaning to remove dirt, chips, oil and other foreign material from the articles prior to assembly or further operation on the articles. This has been accomplished in the past by subjecting the articles to a washing operation with a suitable cleansing liquid, commonly a caustic liquid. Some filtration follows the initial washing whereupon the effluent is returned for re use.

U.S. Pat. No. 4,805,652 discloses a wash station for receiving, clamping, inverting, and washing a tank and pallet assembly consists of a stationary frame having a pair of idler rollers and a pair of drive rollers, and a rotatable carriage mounted on the rollers. The carriage includes two separate vertical arcuate wheel members resting on the rollers, a transverse tank support platform extending transversely between the wheel members, transverse support struts, horizontal and vertical wheel support members, and a movable hold down clamp with an integral nozzle assembly. The hold down clamp and nozzle assembly is movable to a clamped position engaging a tank and pallet assembly resting on the support platform. When the assembly is clamped, spray nozzles are inserted within the tank. The carriage containing the tanks to be washed is then rotated 180.degree., inverting the tanks. Wash fluid is then supplied via the spray nozzles into the interior of the tanks. At the completion of a washing operation, the carriage position is reversed and the tank's assembly undamped, thus allowing the removal of the clean tank and pallet assembly from the carriage. The water used in this process is wasted.

The prior art does recognise the need to provide a water purification in industrial water washing. One such water purification process is disclosed in U.S. Pat. No. 5,587,089 which teaches a water purification and dispensing system for purifying water and washing and filling a container with the purified water. The system includes an apparatus comprising a water inlet system, a water purification system, a container washing system, a container filling system, an auxiliary function system, a mineralization system and an ozonating system. The apparatus includes compartments, where a container is washed and filled within a single compartment. This is a complicated washing system and is not suitable for or intended to solely purify water in a separate cycle as it is conducted during a washing system.

U.S. Pat. No. 5,443,739 discloses a water purification and dispensing apparatus with uncontaminated mineral addition. The system comprises a water inlet for obtaining water from a supply source, a water purification system for removing impurities from the source water, a mineral addition system for adding desired minerals into the purified water, the system being sealed against airborne contaminants; and a dispensing system for dispensing the mineralized, purified water into containers. The purification, mineral addition and dispensing systems are contained in a single apparatus that can be transported to a location and connected to a water supply source. This system does not disclose a separate purification system which provides recycled water for a washing process.

There is a long felt want in the industry to provide an alternative to the known methods of industrial water washing and particularly in the pallet pad recycling industry. There is a need to provide a simple but effective contaminated water purification and recycling system which treats contaminated water, through various filtration stages and which includes subsystems for re treatment of water during decontamination. There is a further need to recycle pallet pads and to ensure that they are efficiently and economically cleaned for reuse and without waste of cleaning water.

### INVENTION

The present invention provides a system for purification and recovery of contaminated water from an industrial washing process. The invention further provides a system for treatment and re treatment of contaminated wash water used for industrial cleaning. The invention further provides an improved process for treatment and recycling of waste water used for industrial washing and which employs at least one primary filtration station, a mixing station, in which chemicals are mixed with effluent, a settlement station and a final filtration station. The invention further provides a process which enables recycling of pallet pads which are washed following which the wash water is collected, decontaminated and returned for reuse.

In its broadest form the present invention comprises:

a process for the purification and recovery of a contaminated liquid, the process comprising:
a source of contaminated liquid effluent,
a primary filtration station having at least one filter;
a first holding tank for receiving effluent from the primary filtration station,
a dosing station;
a mixing station;
at least one other filtration station; and wherein, effluent passing from said at least one other filtration station is returnable to the primary filtration station for
further filtration or recoverable from the system.

In another broad form the present invention comprises:

a wash water purification and recovery process the process comprising:
a source of contaminated effluent,
a primary filtration station having at least one sand filter;
a first holding tank for receiving effluent from the primary filtration station,
a dosing station;
a mixing station;
a second filtration station; and a third filtration station; wherein effluent from said third filtration station is returnable to the primary filtration station, or recoverable from the process.

In another broad form the present invention comprises:

a wash water purification and recovery process for recycling wash water used in pallet pad washing, the process comprising:
a source of contaminated effluent,
a primary filtration station having at least one sand filter;
a first holding tank for receiving effluent from the primary filtration station,
a dosing station;
a mixing station;
a settling station;
a second filtration station; and a third filtration station; wherein effluent from said third filtration station is returnable to the primary filtration station or recoverable from the process.

In another broad form the present invention comprises:

a wash water purification and recovery process for recycling wash water used in pallet pad washing, the process comprising:
a source of contaminated effluent,
a primary filtration station having at least one sand filter;
a first holding tank for receiving effluent from the primary filtration station,
a dosing station including chemicals which are delivered to effluent from the holding tank;
a mixing station in which the chemicals from the dosing station are mixed with the effluent;
a settling station in which solids in the effluent are allowed to settle;
a second filtration station; and a third filtration station receiving effluent from said second filtering station; wherein, effluent from said third filtration station is returnable to the primary filtration station or recoverable from the process fox reuse as decontaminated wash water.

According to a preferred embodiment, effluent may be passed through the filtration stations multiple times depending upon the level of contamination and capacity (scale size) of the purification system. A first holding tank preferably has a level gauge for determination of content level in the holding tank. After primary filtration the effluent is introduced into the holding tank which includes a submerged pump. Effluent for treatment is pumped via diaphragm pump into a supply line which is in communication with at least one dosing tank which provides a caustic purifier. The effluent is then pumped via a mixer which mixing the caustic solution, into a clarifier where heavy settled contaminants gravitate to the bottom the clarifier. A valve in the bottom of the clarifier allows more contaminated water to be drained off for re treatment via the holding tank and settled solids to be removed altogether for disposal. This re treatment cycle can be repeated as many times are required depending upon the level of contamination. A draw off pipe in the clarifier is located higher in the clarifier than the draw off valve and delivers water to a diaphragm pump which urges water into a secondary treatment station. The secondary treatment station comprises at least one holding tank and a supply line to the tanks. The supply line includes a sand filter through which the water passes prior to delivery to the at least one holding tank. The holding tank has according to one embodiment a first outlet which draws off water for transmission through a tertiary filtration station in which there are sand filters which further filter the water prior to treatment by an ultra violet sanitiser following which the treated water is returned to a holding tank for re use or return to the primary filtration for re treatment. Tertiary filtration is preferably via a charcoal filer.

These and other objects, features and advantages of the present invention will become apparent after a review of the following detailed description of the disclosed embodiments. The present invention provides an alternative to the known, prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views.

The following detailed description is, therefore, not to be taken in a limiting sense, and the scope of the present invention is best defined by the appended claims.

### BRIEF DESCRIPTION OF DRAWINGS

The present invention will now be described in more detail according to a preferred but non limiting embodiment and with reference to the accompanying illustrations: wherein;

FIG. 1 shows a schematic view of a process flow diagram for purification and recycling of contaminated wash water, according to a preferred embodiment.

### DETAILED DESCRIPTION

The invention will be described below with reference to a preferred but non limiting embodiment of the waste water recovery system and associated method for recycling wash, water. The invention is particularly suited to its application in the pallet industry and particularly the washing of pads used in beverage packing, but it will be appreciated that the water recovery system may be adapted to a variety of industrial wash applications requiring high level water usage.

Waste water is pumped from a tank containing effluent from a pallet pad washing process. In the past this water would have been wasted but with the current need for water, conservation the present invention provides a process which will allow wash effluent to be collected, purified and reused, in potentially an unlimited number of cycles as required.

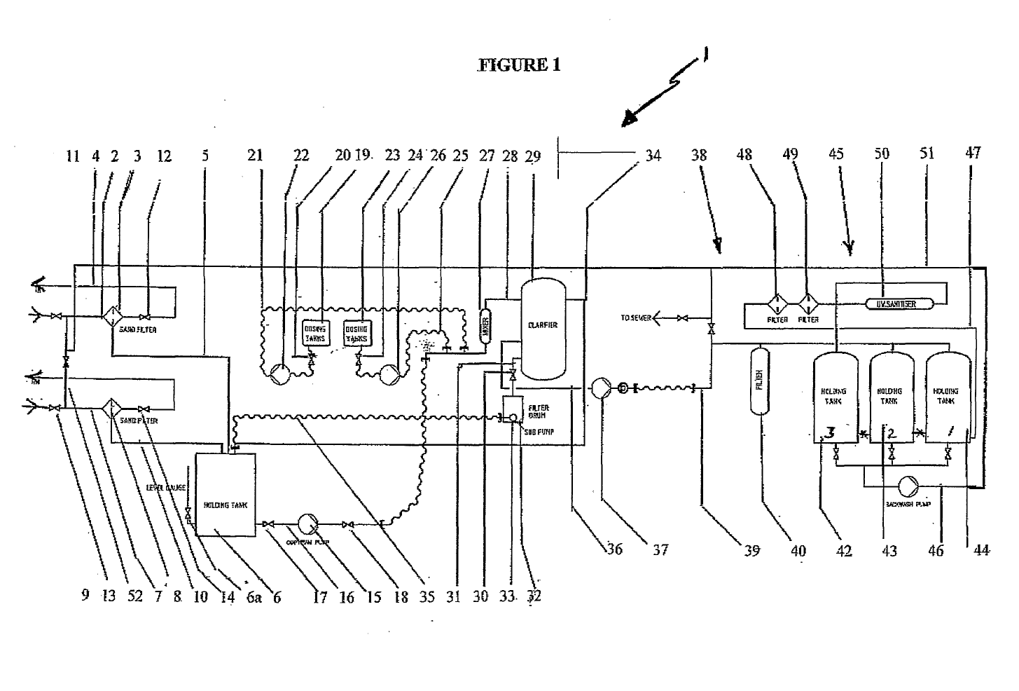

FIG. 1 shows a schematic view of a process 1 for purification and recycling of contaminated wash water according to a preferred embodiment.

Process 1 comprises a first wash supply line 2 delivering effluent water to a first sand filter station 3. Water exiting filter station 3 may either be returned through wash return line 4 or delivered through feed line 5 to holding tank 6. In the embodiment shown, process 1 further comprises a second rinse supply line 7 delivering effluent water to a second sand filter station 8. Water exiting second filter station 8 may either be returned through rinse return line 9 or delivered through line 10 to holding tank 6. Holding tank 6 preferably has a level gauge for determination of content level in the holding tank.

Effluent is first passed through primary sand filtration which comprises, at least one sand filtration station. The effluent may be passed through the sand filter stations multiple times depending upon the level of contamination and capacity (scale size) of the purification process.

Wash supply line 2 comprises a valve 11 which regulates the flow therethrough. Line 4 also includes a valve 12 which regulates the wash return cycle. Rinse supply line 7 comprises a valve 13 which regulates the flow therethrough. Line 9 also includes a valve 14 which regulates the rinse return cycle.

After primary filtration, effluent is introduced into holding tank 6 which includes either a submerged pump (not shown) or an external diaphragm pump 15 located in line 16. Valve 17 regulates the flow of water to pump 15. Line 16 further comprises a valve 18 which controls flow of contaminated water in line 16 downstream of pump 15. Effluent for treatment is pumped via diaphragm pump 15 into supply line 16 which is in communication with at least one dosing tank which provides a caustic purifier. Dosing tank 19 delivers a dosing chemical which may be alum via valve 20 into line 21 via pump 22 which delivers the dosing chemical via line 21 into line 16. Likewise, dosing tank 23 delivers a dosing chemical which may also be alum via valve 24 into line 25 via pump 26 which delivers the dosing chemical via line 25 into line 16.

The effluent is then, pumped through a mixer 27 which mixes the caustic solution from dosing tanks 19 and 23, and via a line 28 into a clarifier 29 where heavy settled contaminants gravitate to the bottom the clarifier. A valve 30 in the bottom of the clarifier 29 allows more contaminated water to be drained off for re treatment via the holding tank 6 and settled solids to be removed altogether for disposal. This re treatment cycle can be repeated as many times are required depending upon the level of contamination. Line 31 delivers effluent to filter drum 32 which includes a sub pump 33 to deliver effluent back to holding tank 6.

A draw off pipe 34 in the clarifier 29 is located higher in the clarifier than the draw off valve 30 and delivers water via line 35 to holding tank 6 for further dosing re treatment. Draw off line 36 from clarifier 29 takes water to a diaphragm pump 37 which urges water into a secondary treatment station 38 via line 39. The secondary treatment station 38 comprises a sand filter 40 which receives water through line 41 from line 39. Station 38 also comprises a series of holding tanks 42, 43 and 44 which hold treated water front filter 40 and water treated through station 45. According to one embodiment, water from line 41 enters holding tanks 43 and 44. The water stored in these two tanks can either be returned for reprocessing through the system via line 46, or processed through treatment station 45 via line 47. Treatment station 45 comprises sand filters 48 and 49 disposed in series in line 47. Water processed through station 45 is passed though a UV sanitizer 50 whereupon treated water is returned via line 51 to tank 42. Treated water may be either returned to tank 44 for reprocessing through station 45 or delivered via line 46 back to line 52 for further processing through the purification process.

Filtration is preferably effected via a charcoal or sand filter but it will be appreciated by persons skilled in the art that other forms of filtration may be used

The process described can process treated water at the rate of least 80 litres per minute. Preferably the flocculant used in the process is alum or Aluminium Chlorohydrate which assists in settlement of unwanted solids.

In order to demonstrate the efficacy of the treatment process, trade waste was tested before and after treatment with the process of the present invention. Trade waste was treated with flocculation and sand filtration and treated water was recycled for initial wash.

Results of a sample of waste water before and after treatment are set out in table 1 below:

TABLE 1

| Element | Pre Treatment | | After Treatment | |
|---|---|---|---|---|
| BOD | 74 | mg/l | 21 | mg/l |
| Suspended solids | 210 | mg/l | <2 | mg/l |
| pH | 8.1 | | 7.8 | |
| SO₄ | 33 | mg/l | 18 | mg/l |
| Total Phosphorous | 9 | mg/l | <0.1 | mg/l |
| TKN | 4.7 | mg/l | 0.6 | mg/l |
| Oil and Grease | 2 | mg/l | <2 | mg/l |
| TDS | 540 | mg/l | 440 | mg/l |

It may be seen from the above table that contaminants such as suspended solids, sulphates, phosphorous, oil and grease and total dissolved solids are significantly reduced. Notably the suspended solids are substantially reduced to an almost negligible level. The process according to one embodiment of the invention is adapted for recovery of wash water for washing

It will be recognised by persons skilled in the art that numerous variations and modifications may be made to the invention broadly described herein, such as but not limited to fire control without departing from the overall spirit and scope of the invention.

1. A process for the purification end recovery of a contaminated liquid, the process comprising:
a source of contaminated liquid effluent,
a primary filtration station having at least one filter;
a first holding tank for receiving effluent from the primary filtration station, a dosing station;
a mixing station;
at least one other filtration station; and wherein, effluent passing from said at least one other filtration station is returnable to the primary filtration station for further filtration or recoverable from the system.

2. A process according to claim 1 wherein, there is a third filtration station which discharges the effluent returnable to the primary filtration station or recoverable from the system.

3. A process according to claim 2 wherein the dosing station includes at least one dosing tank, which delivers a dosing chemical into at least one supply line to said mixing station.

4. A process according to claim 3 wherein the mixing station includes a mixing tank.

5. A process according to claim 4 wherein the mixing station receives a caustic solution from the at least one dosing tanks.

6. A process according to claim 5 further comprising a clarifier.

7. A process according to claim 6 wherein the caustic solution from said mixing station is delivered to said clarifier.

8. A process according to claim 7 wherein heavy solids delivered to said clarifier settle to the bottom of the clarifier.

9. A process according to claim 8 wherein the process further comprises a first wash supply line delivering effluent water to a first sand filter station.

10. A process according to claim 9 wherein water exiting said first filter station is either returned through a wash return line or delivered through a feed line to a first holding tank.

11. A process according to claim 10 further comprising a second supply line delivering effluent water to a second send filter station.

12. A process according to claim 11 wherein water exiting second filter station is either returned through a rinse return line or delivered a supply line to the holding tank.

13. A process according to claim 12 wherein the holding tank includes a level gauge for determination of content level in the holding tank.

14. A process according to claim 13 wherein filtration media for the filters are selected from sand or charcoal.

15. A process according to claim 14 wherein the contaminated effluent can be passed through the filter stations multiple times depending upon the level of contamination of the source liquid.

16. A process according to claim 15 wherein after primary filtration, at the first filtration station, effluent is introduced into the holding tank.

17. A process according to claim 16 wherein, the holding tank has an associated pump.

18. A process according to claim 17 wherein effluent from the holding tank is pumped to the at least one dosing tank.

19. A process according to claim 18 wherein a valve is provided in the clarifier thereby allowing contaminated water to be drained off for re treatment via the holding tank.

20. A process according to claim 19 wherein said settled solids are removable from the clarifier for disposal.

21-40. (canceled)
